(19) United States
(12) Patent Application Publication
(10) Pub. No.: US 2014/0300733 A1
(43) Pub. Date: Oct. 9, 2014

(54) MOBILE DEVICE BALL SPEED TRACKING

(71) Applicant: Kenneth B. Mitchell, Santa Monica, CA (US)

(72) Inventor: Kenneth B. Mitchell, Santa Monica, CA (US)

(21) Appl. No.: 13/858,729

(22) Filed: Apr. 8, 2013

(51) Int. Cl. G06K 9/00; G06T 7/20

(52) U.S. Cl. CPC G06K 9/00671; G06T 7/20
USPC 348/135

(57) ABSTRACT

A process for determining the speed of a moving sport ball using a mobile device having a camera, the process comprising: providing instructions to a user on how to position the mobile device relative to a sport court of a known layout and in relation to which the sport ball is expected to move; providing feedback to the user about the position of the mobile device; determining the position of the mobile device relative to the sport court; video shooting of the moving sport ball using the camera of the mobile device; analyzing the video of the moving sport ball and extracting from the video the data necessary for computing the speed of the moving sport ball; computing the speed of the moving sport ball; and, displaying the computed speed on the screen of the mobile device.

### BACKGROUND OF THE INVENTION

1. Field of the Invention

The invention relates generally to mobile technology and more particularly to a mobile device system and module for tracking the speed of a flying ball.

2. Description of the Related Art

As mobile devices become cheaper every day, an increasing number of users are in possession of such devices, including smart phones. Today, besides making a phone call, a user may accomplish many more tasks with a smart phone (e.g., searching the internet). There is a continuous user/consumer need to expand the uses and capabilities of mobile devices such as smart phones. For example, a smart phone user may be a tennis player, and she would be interested in using her smart phone to track the speed of her serve. The tennis player may use such results to track her performance progress and the efficacy of the training techniques she uses, or simply to compare and compete with other players. While there appear to be available on the market some apps running on mobile devices, which give the user the option to calculate the speed of a flying ball, those apps require manual input of one or more data by the user. The manual input is time consuming, subject to errors, and thus, those apps are unattractive. Thus, there is a need for an automated and reliable mobile solution for tracking the speed of a flying ball.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment a user positions a mobile device perpendicular to the scene that includes a flying ball, and upon activation, an application is configured to video record the flying ball, calculate the speed of the ball and display the calculated speed on the screen of the mobile device. Thus, an advantage is the automation of the ball speed tracking process using a mobile device.

In another exemplary embodiment a video overlay guiding grid is used to assist the user in finding desirable viewing angles that lead to increased accuracy in ball speed calculations. Thus, an advantage is the increased reliability of the application.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 is a flow chart depicting a process for ball speed tracking, according to an embodiment.

FIG. 2 illustrates the top view of a tennis court and exemplary positions of a mobile device on the side of the tennis court, according to other embodiments

FIG. 3 is a front view a mobile device displaying an exemplary viewing angle of the mobile device's camera, according to another embodiment

FIG. 4 illustrates a top view of a mobile device displaying an exemplary viewing angle of the mobile device's camera and a predefined ball search region, according to another embodiment.

FIG. 5 is a front view of a mobile device displaying an exemplary viewing angle of the mobile device's camera and an exemplary ball speed, according to another embodiment.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention.

As used herein and throughout this disclosure, the term “mobile device” refers to any electronic device having a camera capable of recording videos, and typically the electronic device is also capable of communicating across a mobile network. A mobile device may have a processor, a memory, a transceiver, an input, and an output. Examples of such devices include cellular telephones, smart phones, tablet computers, personal digital assistants (PDAs), portable computers, etc. The memory stores applications, software, or logic. Examples of processors are computer processors (processing units), microprocessors, digital signal processors, controllers and microcontrollers, etc.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database.

For the following description, it can be assumed that most correspondingly labeled structures across the figures (e.g., 330 and 430, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

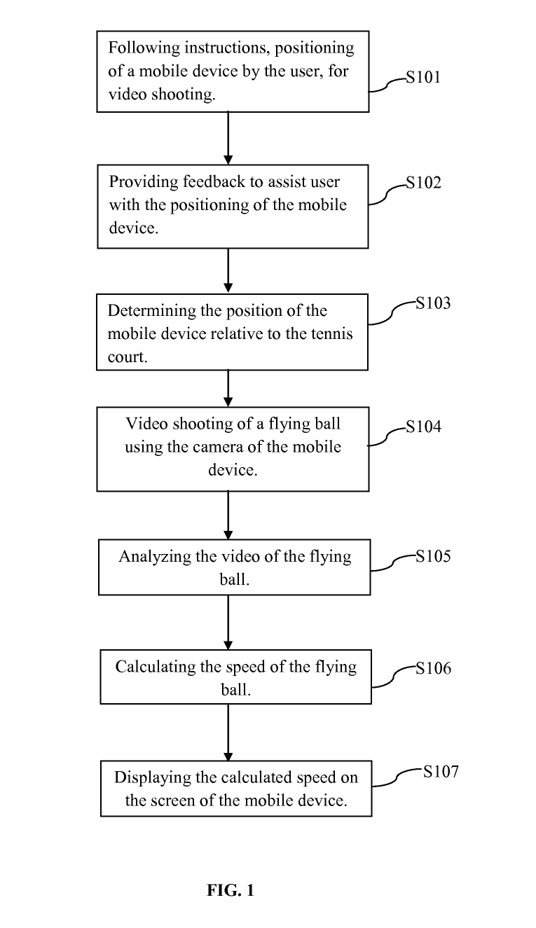

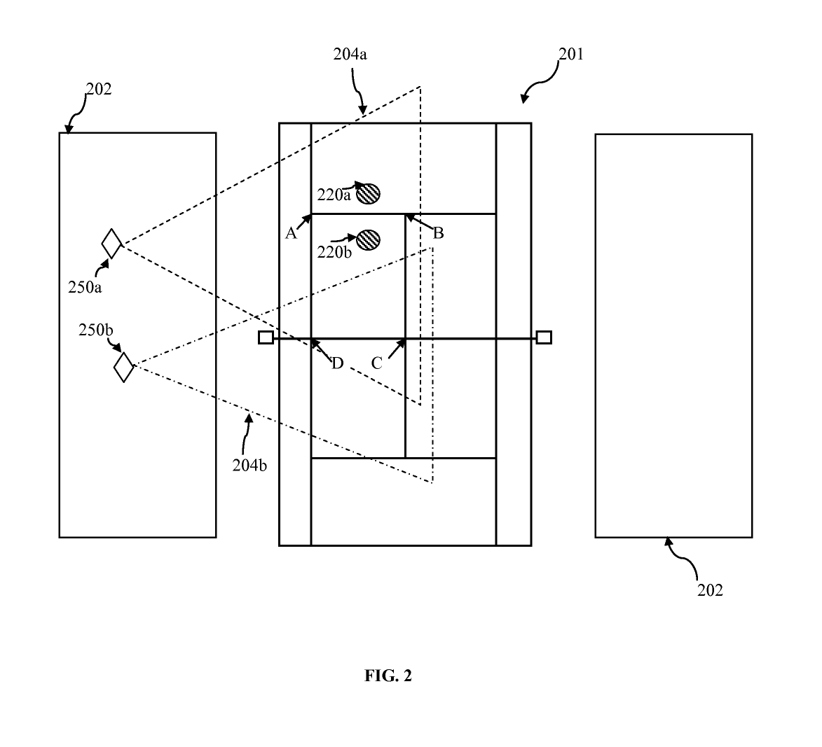

FIG. 1 is a flow chart depicting a process for ball speed tracking, according to an embodiment. In the first step S101, following instruction of the speed tracking module a mobile device user positions the mobile device on the side of the tennis court as exemplarily shown in FIG. 2. Once launched by the user, the ball speed tracking module (hereinafter, “module,” “application module,” “application” or “app”), which was previously loaded into the mobile device, may preferably be configured to provide instructions (S101) to the user on how to position the mobile device in position for shooting from a supported angle (e.g., “place camera perpendicular to the scene and match the guiding grid to the court's layout,” spoken or displayed). Feedback to user (step S102) as to the correct position of the mobile device necessary for better module accuracy may also be provided. For example, the guiding grid may be highlighted when the mobile device is in the position supported by the app. More on the feedback and correct position will be disclosed below.

Once the user positions the mobile device as instructed by the module in steps S101, S102, the app may be configured to determine the position (step S103) of the mobile device relative to the tennis court. Determining the position of the mobile device is important for the calculation of the speed of a flying ball, as described in details below when referring to FIG. 2. Next, the user causes the mobile device to video record the moving ball (step S104), the speed of which the user wishes to determine. Alternatively, the app may be configured to automatically start shooting when the mobile device is in the supported position and/or a flying ball is detected.

Next, the recorded video is analyzed (step S105) to extract the data (e.g., ball's position in successive images) necessary to calculate the speed of the flying ball. Next, in step S106, the module calculates the speed of the tracked ball. Finally, in step S107, the app diplays the calculated speed as exemplary shown in FIG. 5. More details about steps S101-107 will be presented below when referring to FIGS. 2-5.

Thus, the mobile device equipped with the ball speed tracking module provides an automated solution to the need of calculating ball speeds, for, for example, the purpose of training a player (e.g., a tennis player).

For exemplification purposes, this disclosure describes the tracking of a tennis ball based on a side view, as it is typical for people to watch the sport from the side, and on enabling a “point and shoot” type of application for determining the speed of a flying tennis ball. However, one of ordinary skills in the art would recognize that the technological process and system described herein may be adapted to other, non-side views, such as views from the end of the court, and to other sports, without departing from the scope and essence of the invention. The lists of such other sports, besides tennis, includes but is not limited to baseball, soccer, cricket, track and field, game of catch, golf (club speed), hockey and volleyball.

FIG. 2 illustrates the top view of a tennis court 201 and exemplary positions of a mobile device on the side of the tennis court, according to other embodiments. The mobile device may be positioned on either side of the tennis court 201 anywhere inside the exemplary areas 202. With side view sports, such as tennis, it means that the user is typically located on the side of the court 201 and the expectation is that she will point her mobile camera (e.g., a mobile device having a camera) perpendicular or substantially perpendicular to the scene that will include the flying ball. Again, possible user/mobile device locations are illustrated by the 202 rectangles and the camera is expected to be pointed, or the user should preferably be instructed by the app to point it, perpendicular or substantially perpendicular to the scene as illustratively shown by triangles 204 a-b.

Reference points such as shown points A, B, C and D, may be used to determine and/or calibrate the mobile device's position (e.g., 250a or 250b), according to another embodiment. Once the module is activated, the module determines and calibrates the device's location relative to the tennis court 201 as explained hereinafter. To do so, the module may be configured to assume that at least two known reference points (e.g., B and C), are visible in the camera when the user video shoots the flying ball. Thus, since the actual distance between the two reference points (e.g., B and C) on the tennis court is known, that information may be used to determine, for example, the scale between a particular distance in the video such as the distance between the flying ball's positions 220a and 220b, and the corresponding actual distance covered by the ball. By analyzing the captured video and comparing the distance in the video between, for example, reference point B and C with the actual known distance on the court between same points, and by factoring in the camera parameters, the app may calculate the distance between the camera and the longitudinal center line of the tennis court (containing the points B and C).

This also means that the scale relative to the center line of the tennis court would be known (from a simple division by the app of the distance between points B and C in the video to the actual distance between these two exemplary points). Similarly, the scale relative to the side line containing reference points A and D may be calculated by the app. It should be apparent that all tennis court's corners and line intersection points may be used as reference points.

The flying ball's trajectory may be determined by the app analyzing the video for the relative positions (e.g., 220a, 220b) of the flying ball at various times with respect to the captured reference points, A, B and C for example. From the same video analysis the scale used to determine the actual distance traveled by the ball in the given amount of time, and thus, the speed of the ball (since it is known that v=d/t (or speed equal distance divided by time)), may need to be adjusted by, for example, calculating a weighted average between the scale at line A-D and scale at line B-C.

It should be noted that from the geometry of a standard tennis court, many distances between the court's reference points are known, such as the diagonal distance between reference point A and reference point C. Furthermore, the relative position of each reference point with respect to each of the other is known from the geometry of the tennis court. Thus, all this data may be incorporated in the app and used by the app the determine the actual trajectory of the flying ball and/or the scale associated with the trajectory of the flying ball, and thus, the actual distance travelled by the flying ball in the respective amount of time and finally the ball's speed.

During the video analysis performed by the app, the reference points and the flying ball's positions may be detected and tracked from multiple frames or image sequences.

Again, the known geometry of a standard tennis court, including distances between various reference points, and the camera field of view parameters together with detected reference points may be used by the app to calculate the camera's position relative to the court. it should be noted that not only the distance of the camera from the longitudinal center line B-C (or side line A-D) may be determined as mentioned earlier, but also the camera's position with respect to for example, the transversal center line D-C. For example, in FIG. 2 it can be seen that camera position 250b is closer to the transversal center line D-C than the camera position 250a. This additional data about the position of the camera relative to the tennis court may be used to, for example, determine at what relative position from the tennis court's net the speed of the flying ball was calculated.

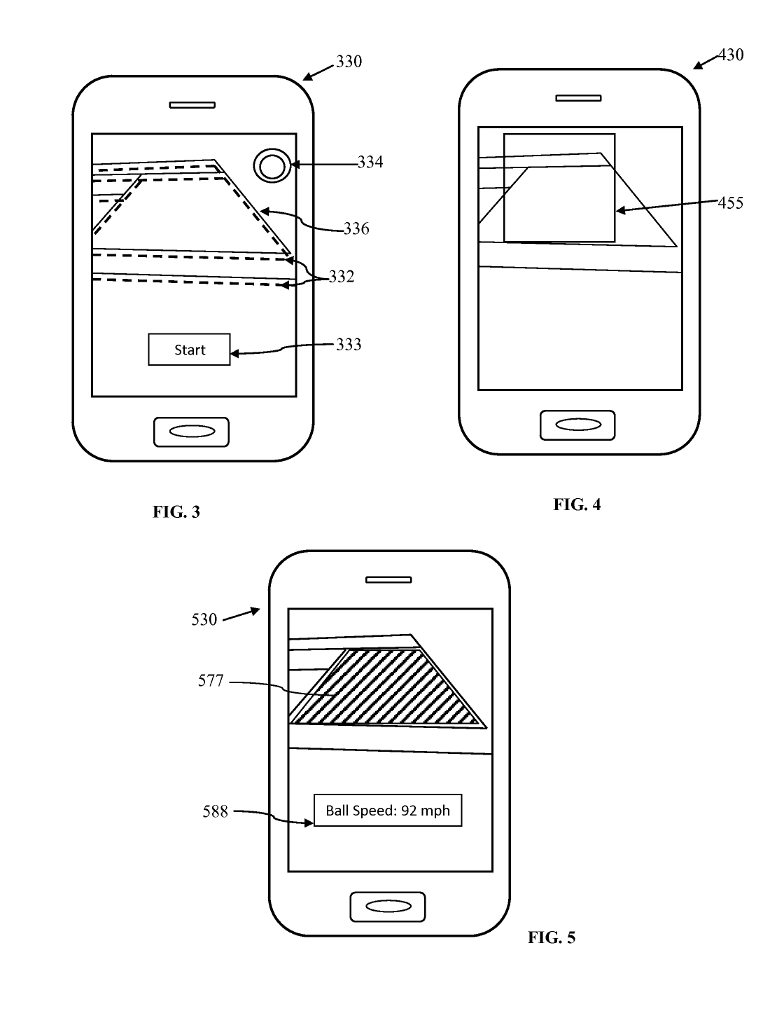

FIG. 3 is a front view of a mobile device 330 displaying an exemplary viewing angle of the mobile device's camera, according to another embodiment. The application module may be configured to use a video overlay guiding grid 332 that mimics the tennis court's layout 336, for the purpose of limiting the shooting angle(s) to known good ones that would lead to accurate ball speed calculations. The app may also be configured to recognize the supported view angle(s) (e.g., perpendicular) and may also be configured to give the user feedback about it to assist the user in positioning the mobile device such that the desired shooting angle of the camera is obtained. The feedback may be accomplished by displaying on the mobile device's screen short messages such as “move the camera until the guiding grid matches the tennis court's layout.” Other alternative means may be used to guide the user to position the camera in the desired shooting angle, such as by using a bullseye-like guide 334 displayed on the screen (e.g., when the two circles are concentric, the camera is in the desired shooting position). Another example of alternative means that may be used to guide the user to position the camera in the desired shooting angle is a matching area guide 577 as shown in FIG. 5. Simply, the user may be asked to match the area 577 to the corresponding area in the tennis court's layout, and then, for example, when matching is achieved, the area 577 may appear highlighted.

A touch button 333 may also be provided, as one of the possible ways to start, video shooting, once the desired viewing angle is obtained. The app may be configured to make button 333 active only after the required camera position is obtained as described above following the apps guidance. The button 333 may be highlighted when active.

FIG. 4 is a front view of a mobile device 430 displaying an exemplary viewing angle of the mobile device's camera and a predefined ball search region 455, according to another embodiment. When the camera position with respect to the tennis court is known by the app as described earlier, the app may be configured to limit the ball search region 505 in the camera view to some predefined area. This approach may simplify the video analysis algorithm. The ball may be assumed to appear as bright spots at certain scale in the images which are then searched during the app's video analysis from the predefined region.

FIG. 5 illustrates the front view of a mobile device 530 displaying an exemplary viewing angle of the mobile device's camera and an exemplary ball speed 588, according to another embodiment. In the final step, the speed of the flying ball is being calculated by the app and then displayed to the user. As described earlier, the trajectory of the ball together with the associated time and the known camera position and parameters are used by the ball speed tracking module to derive the speed of the ball. The result 588 is displayed on the mobile device's screen for the user to see and use.

Besides ball speed tracking, the application module may also have social media. capabilities, such as allowing the user to post a calculated ball speed on a social media site. The social media features of the app may help with its marketing.

One of ordinary skills in the art would recognize that the accuracy of the calculated ball speed may depend on the available technologies (video analysis technology, camera capabilities, mobile device's processing capabilities, etc), now or in the future, to implement the processes described herein. However, the essence of the processes disclosed herein remains the same.

It should be noted that alternatively the app described herein and installed into a mobile device may be configured to send all or a portion of the collected data described earlier (e.g., video, data about the position of the device, etc) over a network to a server for partial or complete processing. When the server completes the calculations, the server may be instructed to return the result to the mobile device. If the result is the speed of the ball, the mobile device will then display it on the mobile device's screen and/or it will otherwise make it available to the user (e.g., storing it for a later access). Using a server to process all or a portion of the computations may be preferred when the mobile device's processing power is not adequate for calculating the speed and displaying it to the user within a reasonable time (e.g., 5 seconds).

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention .

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein.

What is claimed is:

1. A process for determining the speed of a moving sport ball using a mobile device having a camera, the process comprising: providing instructions to a user on how to position the mobile device relative to a sport court of a known layout and in relation to which the sport ball is expected to move; providing feedback to the user about the position of the mobile device; determining the position of the mobile device relative to the sport court; video shooting of the moving sport ball using the camera of the mobile device; analyzing the video of the moving sport ball and extracting from the video the data necessary for computing the speed of the moving sport ball, wherein said data comprises the positions of the moving sport ball in a plurality of frames of the video relative to a plurality of predetermined reference points located on the sport court, wherein the actual distance between the predetermined reference points on the sport court is known; computing the speed of the moving sport ball; and, displaying the computed speed on the screen of the mobile device.

2. The process from claim 1, wherein the sport court is a tennis court and the moving sport ball is a flying served tennis ball, and wherein the instructions to the user are to position the mobile device on the side of the tennis court and perpendicular to the sideline of the tennis court.

3. The process from claim 2, wherein the instructions and the feedback to the user comprise a requirement that the mobile device be moved until a video overlay guiding grid which appears on the screen of the mobile device, and which mimics at least a portion of the tennis court's layout, matches the corresponding at least a portion of the tennis court's layout appearing in camera view, and wherein the requirement's purpose is to limit the shooting angle to a predetermined one that leads to reliable speed calculation.

4. The process from claim 2, wherein the instructions and the feedback to the user comprise a requirement that the mobile device be moved until a matching area guide appearing on the screen of the mobile device matches the corresponding area in the tennis court's layout appearing in camera view.

5. The process from claim 2, wherein determining the position of the mobile device relative to the tennis court comprises determining the distance of the camera from a line comprising at least two of the plurality of predetermined reference points.

6. The process from claim 2, wherein the plurality of predetermined reference points comprises points where the lines of the tennis court's layout intersect.

7. The process from claim 2, wherein analyzing the video is limited to the frames of the video that correspond to a predefined tennis ball search region, and wherein the tennis ball is assumed to appear as bright spots at a certain scale in the respective frames.

8. The process from claim 2, wherein the step of computing the speed of the tennis ball comprises using the camera field of view parameters and the actual, known distance between the predetermined reference points on the tennis court.

9. The process from claim 2, wherein the steps of analyzing the video and computing the speed of the tennis ball are performed by the mobile device.

10. The process from claim 2, wherein the steps of analyzing the video and computing the speed of the tennis ball are performed by a server with which the mobile device communicates via a network.

11. A mobile device configured to determine the speed of a moving sport ball by performing a process comprising the steps of: providing instructions to a user on how to position the mobile device relative to a sport court of a known layout and in relation to which the sport ball is expected to move; providing feedback to the user about the position of the mobile device; determining the position of the mobile device relative to the sport court; video shooting of the moving sport ball using the camera of the mobile device; analyzing the video of the moving sport ball and extracting from the video the data necessary for computing the speed of the moving sport ball, wherein said data comprises the positions of the moving sport ball in a plurality of frames of the video relative to a plurality of predetermined reference points located on the sport court, wherein the actual distance between the predetermined reference points on the sport court is known; computing the speed of the moving sport ball; and, displaying the computed speed on the screen of the mobile device.
